(19) United States
(12) Patent Application Publication
(10) Pub. No.: US 2026/0125035 A1
(43) Pub. Date: May 7, 2026

(54) BRAKING SYSTEM WITH FLEXIBLE ARCHITECTURE AND METHOD FOR OPERATING SUCH A BRAKING SYSTEM

(71) Applicant: Continental Automotive Technologies GmbH, Hannover (DE)

(72) Inventors: Thorsten Ullrich, Gernsheim (DE); Martin Baechle, Kelkheim (DE); Achim Netz, Rodgau (DE); Mathias Haag, Darmstadt (DE)

(73) Assignee: Continental Automotive Technologies GmbH, Hannover (DE)

(21) Appl. No.: 19/114,298

(22) PCT Filed: Sep. 6, 2023
(86) PCT No.: PCT/DE2023/200178

§ 371 Date: Mar. 21, 2025

(30) Foreign Application Priority Data
Sep. 21, 2022 (DE) 10 2022 209 930.3

(51) Int. Cl. B60T 8/172; B60T 7/04; B60T 8/171; B60T 13/74

(52) U.S. Cl. CPC B60T 8/172; B60T 7/042; B60T 8/171; B60T 13/746; B60T 2220/04; B60T 2270/402; B60T 2270/404; B60T 2270/413; B60T 2270/82

(57) ABSTRACT

A braking system with flexible architecture and a method for operating such a braking system for a motor vehicle are disclosed. The braking system can include a brake pedal with a pedal sensor for detecting the driver input and electrically controllable wheel brake modules.

The pedal sensor can be connected to an electronic control unit, which generates control information for the electronic power unit from the braking information of the pedal sensor. The electronic power unit is used to control the wheel brakes.

### TECHNICAL FIELD

The embodiments generally relate to a braking system with flexible architecture and to a method for operating such a braking system for a motor vehicle.

### BACKGROUND

In motor vehicle technology, “brake-by-wire” braking systems are being used ever more widely. Braking systems of this kind often comprise a brake pedal which is designed as an electronic pedal. The brake pedal detects a driver braking input by means of a sensor and, from this, generates a driver braking input signal. In these braking systems, the driver can be decoupled from direct access to the brakes. The detected braking input can lead to the determination of a setpoint braking torque, from which the setpoint brake pressure for the brakes can then be obtained.

Here, the wheel brakes can be designed as electromechanical (dry) brakes. The driver braking input signal can be transmitted to a central control unit, which performs the electric control of the wheel brakes.

However, with such a design of the braking system, if a central control unit fails, it is immediately necessary to switch to a fallback level in order to be able to maintain essential functions of the braking system.

Against this background, an operating system with improved safety provides a braking system with two axle controllers, wherein a first axle controller is assigned two wheel brake modules and a second axle controller is assigned two further wheel brake modules. Each of the two axle controllers is connected to the brake pedal on a signal input side. In addition, each of the two axle controllers comprises two control units, which each control one wheel brake.

In this concept, the brake pedal is connected to each axle controller. The required functionality for converting the brake signals from the brake pedal into control signals for the control units therefore has to be provided in the axle controller and in particular also in the redundant control units.

In addition, the integration of the “brake-by-wire” braking systems in existing vehicle configurations, which have conventionally been equipped with hydraulic components, requires adaptation to the braking system or to the vehicle configuration, with customer-specific requirements frequently also having to be taken into account.

Accordingly, a braking system is desirable that meets the applicable safety requirements, also with regard to driverless driving, and that can be adapted to different vehicle configurations, customer requirements or safety requirements.

### SUMMARY

This object is achieved by a braking system for a motor vehicle, and by a method for operating a braking system of this kind.

In a first aspect, a braking system for a motor vehicle comprises
a brake pedal with at least one pedal sensor for detecting the driver input;
a plurality electrically controllable wheel brake modules, each comprising an electromechanical wheel brake,
at least one electronic control unit, and
at least one electronic power unit, which is designed to control at least one electromechanical wheel brake,
wherein the pedal sensor is connected via at least one braking input signal line to at least one electronic control unit, and
wherein the at least one electronic control unit is designed to generate control information for the electronic power unit from the braking information of the pedal sensor and to transmit said control information to the electronic power unit.

The braking system is designed as a by-wire braking system and may have a dry brake pedal, also referred to as an electronic pedal. It is also possible to use a “wet” brake pedal, which is correspondingly electrically connected. The brake pedal mat be designed to generate a corresponding signal, also referred to as braking information, from the measured driver's braking input, which signal can be transmitted via at least one braking input signal line to the electronic control unit.

For reasons of redundancy, at least two separate, redundant, that is, two functionally identical braking input signal lines may be provided, which are used for transmitting the signal between the brake pedal and the electronic control unit. For this purpose, the braking input signal line can be configured as a bidirectional braking input signal line. At least one braking input signal line between the brake pedal and each electronic control unit may be provided.

The brake pedal can comprise at least two pedal sensors, which are based on two different measuring principles. Use can be made, by way of example, of a force sensor, which detects the force with which the driver steps on the pedal, and a travel sensor, which measures the distance by which the driver depresses the pedal. With these different pedal sensors, the fault patterns are different, and therefore a jammed pedal, for example, can be detected from the fact that force is exerted on the pedal without the latter moving.

On the basis of the sensor signals, information or signals for the electromechanical braking system that correspond to the driver braking input can be generated. These signals can be transmitted during operation via the braking input signal cable to the electronic control unit.

A first aspect, is based on the concept of grouping or bundling various functionalities, comprising the control and regulation, the operation or the power supply of the electromechanical wheel brakes, hereinafter also referred to in simplified form as elements of the braking system, according to certain criteria or requirements. At this point, it may be mentioned that, within the context of the present application, no distinction is drawn between the terms open-loop control and closed-loop control. The sense of the corresponding terms will be apparent from the respective context.

This makes it possible to implement specific requirements, for example with regard to redundancy and the connection of the braking system to the motor vehicle or to the drive train of the motor vehicle. Redundancy in this context may mean the multiple, for example dual, presence of the corresponding functions or the associated elements. Especially in the case of safety-relevant systems, which include a braking system, a parallel design of functions or elements serves to ensure that, in the event of a failure of one function or element, another takes over these functions, such that, at least to a certain extent, further operation can be made possible.

The braking system is therefore flexible in terms of its architecture and can at the same time be manufactured and adapted to customer specifications. Defined communication interfaces, for example to a data bus of the motor vehicle, can also be provided.

One criterion can be the reduction in the unsprung masses, according to which only the actually necessary components are intended to be mounted on the wheel. In addition to the brake actuators, these include, for example, wheel sensors, such as a motor position sensor and/or a wheel speed sensor. The invention makes it possible to provide braking system architectures matched thereto.

A further criterion can be the provision of the required redundancy of the system-relevant elements, since there is a risk of faults in technical systems that could lead to a reduction in braking capacity under unfavorable circumstances and thus to hazardous situations. It accordingly has to be ensured here that, even in the event of a fault, the driver braking input can be determined and can be implemented with the available brake actuators. The architecture of the braking system may also be optimized in such a way that only certain elements of the braking system have to be designed redundantly.

Another criterion can be the number and the length of the required signal or data bus lines to be provided for the braking system and that are required to connect the various elements of the braking system to one another for signal or data exchange. The number and the length of the required signal or data bus lines may be kept as low as possible.

Another criterion can be the number of points or locations at or in the motor vehicle at which a power supply is to be provided. The number of these points may also be kept low, but at the same time also to minimize the number and length of the power lines.

Against this background, an embodiment, proposes to separate the connection of the pedal sensors and the evaluation of the signals or the generation of the control information structurally and/or spatially from the electronic power unit, which is used for the direct control and the power supply of the wheel brake.

The electronic control unit is therefore designed to generate control information for the electronic power unit from the signals of the brake pedal sensors and to transmit said control information to the electronic power unit via a suitable data bus. This can be done for example with computer assistance on the basis of stored algorithms or by means of suitable software.

The electronic power unit can be designed to control and/or operate the electromechanical wheel brakes starting from or on the basis of the control information.

This makes it possible to arrange the electronic control unit flexibly in the motor vehicle, specifically irrespective of the manner of design of the wheel brake modules. In other words, the electronic power unit can be assigned, for example, directly to a wheel. The wheel brake module can therefore comprise an electromechanical wheel brake and the associated electronic power unit.

In the same way, however, architectures can also be realized in which the electronic power units, for example of two wheels of an axle, are combined in pairs to form an axle controller. In this case, the wheel brake module essentially comprises the wheel brake with a corresponding power supply for the brake actuator, and the power supply and/or the control is performed via the electronic power unit arranged in the axle controller.

Furthermore, architectures can also be realized, in which the electronic power units are diagonally combined in a so-called diagonal controller. A diagonal controller can accordingly comprise two electronic power units for the power supply and/or control of a front wheel and an oppositely arranged rear wheel.

The respective electronic power unit can be flexibly adapted to the specific customer requirements and can be designed, for example, with high redundancy or lower redundancy. A high level of redundancy here can mean that if one element fails, all the functions of that element can be guaranteed by another element, whereas a lower level of redundancy in the event of an element failure can only guarantee some of the eliminated functions. In conjunction with braking systems as described here, this also includes for example the degree of degradation of the braking system.

The electronic control unit can be arranged in the motor vehicle spatially independently of the electronic power unit or the axle or diagonal controller. This makes it possible, for example, to provide the electronic control unit at defined points in the motor vehicle that are particularly readily suitable, for example, to be connected via appropriate interfaces to at least one data bus of the motor vehicle.

For reasons of redundancy, two separate supply voltages may be provided for two electronic control units. In addition, one or two separate supply voltages may also be provided for each electronic power unit or for each axle or diagonal controller.

The electronic control units can communicate with one another in each case via at least one data bus of the motor vehicle, but direct data bus lines can also be provided. Further data bus lines may provided between the electronic control units and the electronic power units or the axle or diagonal controllers.

It is obvious to the skilled person that this results in a multiplicity of possible braking system architectures that can be adapted in a specific case to the corresponding requirements.

For example, all of the wheel brakes of the motor vehicle may be designed as electromechanical or electrically controllable wheel brakes.

In this case, the electromechanical wheel brakes can be embodied as electromechanical disk brakes, in which a brake application force can be produced by means of an electric motor, an auxiliary transmission and a rotation-translation mechanism. In this context, the brake application force refers to the force with which the brake linings are pressed against the brake disk. In operation, a corresponding braking torque is thereby produced at the wheel under consideration. Depending on the embodiment and control concept, the control system can be selected in such a way that either a specified, defined clamping force or a specified, defined braking torque is set in accordance with the deceleration demand requested.

The electromechanical wheel brakes can also be designed as an electromechanical drum brake, in which the motor/transmission unit actuates an expansion module, which presses the brake linings against the brake drum with an expansion force determined on the basis of the desired deceleration requested and thus produces a corresponding braking torque. Depending on the embodiment and control concept, the control system can be embodied in such a way that a defined expansion force or a defined braking torque is set in accordance with the deceleration demand.

In the case of the braking system, for example, the two brakes assigned to the front axle can be embodied as electromechanical disk brakes and the two brakes assigned to the rear axle can be embodied as electromechanical drum brakes. However, all of the brakes may also be embodied as electromechanical disk brakes or electromechanical drum brakes.

When the mechanical connection of the brake pedal to the wheel brakes is decoupled, an external power supply is required that generates a braking torque or clamping force independently of the force exerted by the driver. In an embodiment, a redundant power supply is provided.

The electronic power unit can provide the corresponding power supply or energy supply for the electromechanical wheel brake, for which purpose corresponding power lines to the voltage supply can be provided. In addition, signal lines can also be provided in order to connect, for example, the wheel sensors to the electronic power unit.

A further aspect, also relates to a method for operating a braking system as described above, in particular in conjunction with or for a motor vehicle.

### DESCRIPTION OF THE DRAWINGS

Further details are clear from the description of the illustrated exemplary embodiments and the attached claims.

### In the Drawings:

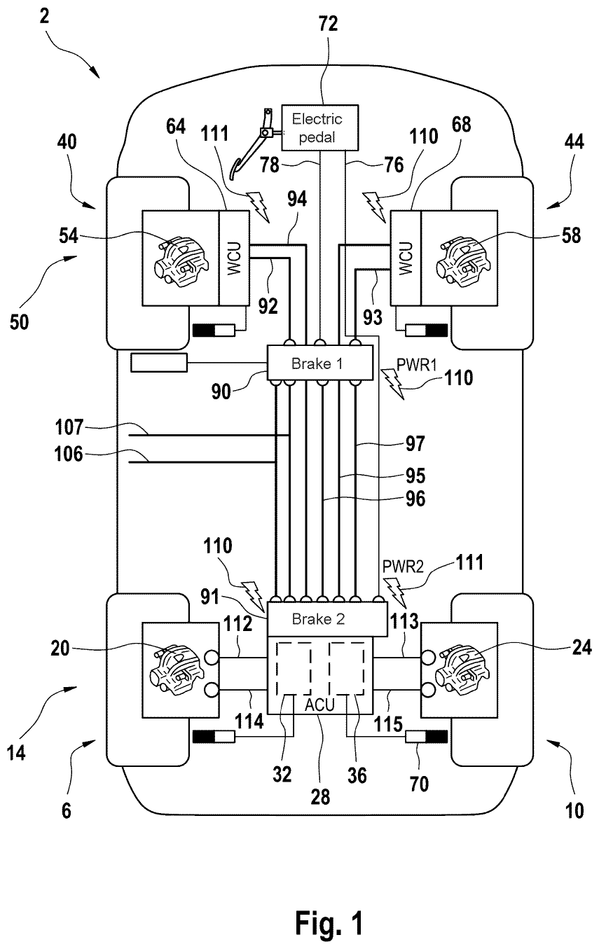

FIG. 1 shows a schematic top view of an example of an architecture of a braking system for a motor vehicle,

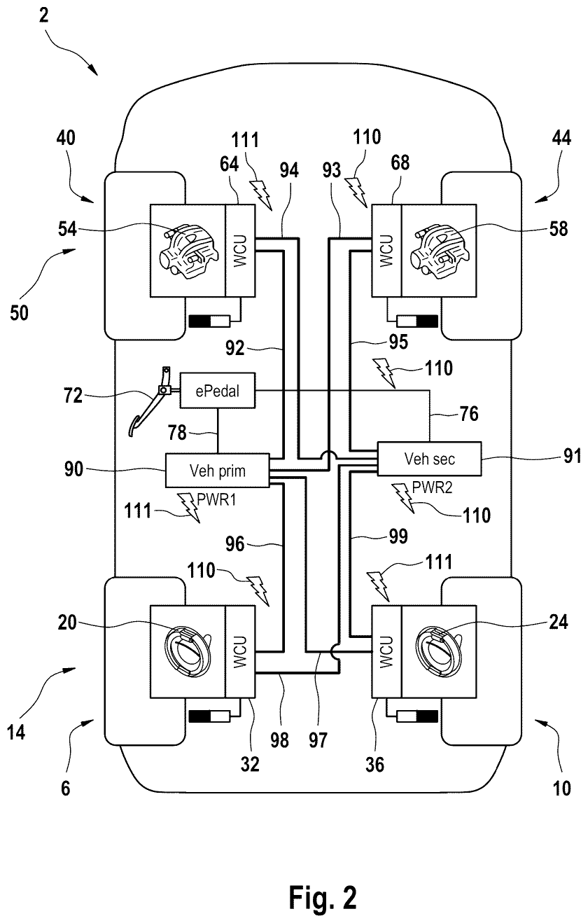

FIG. 2 shows another example of an architecture of a braking system,

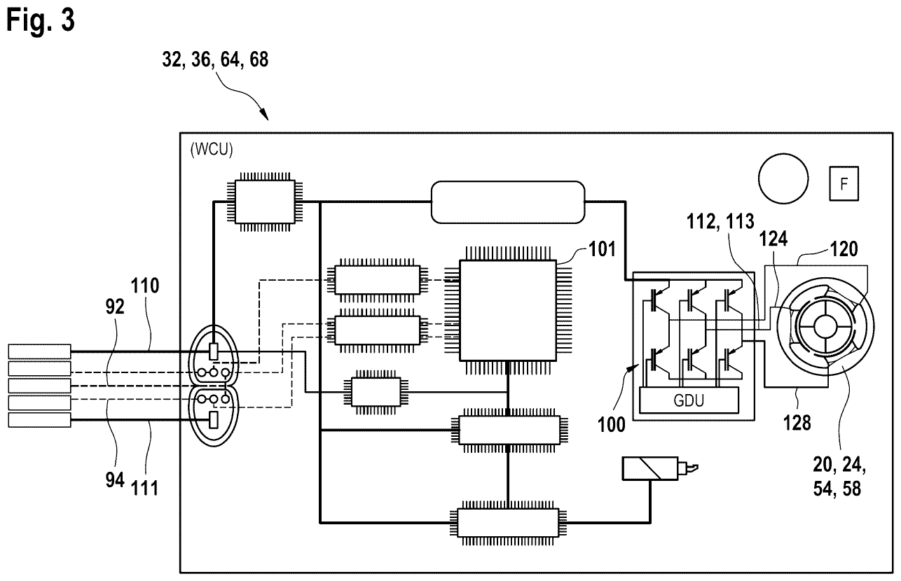

FIG. 3 schematically shows a circuit diagram of an electronic power unit,

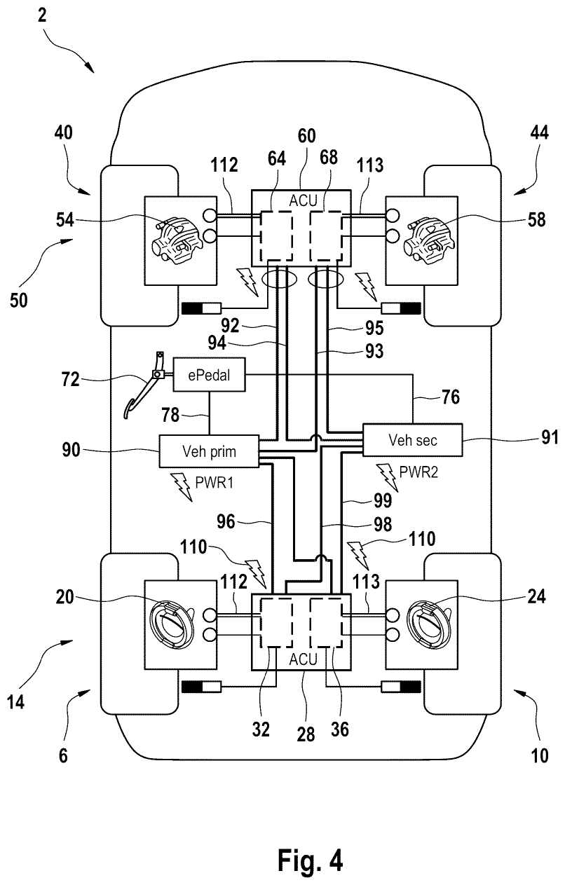

FIG. 4 shows yet another example of an architecture of a braking system,

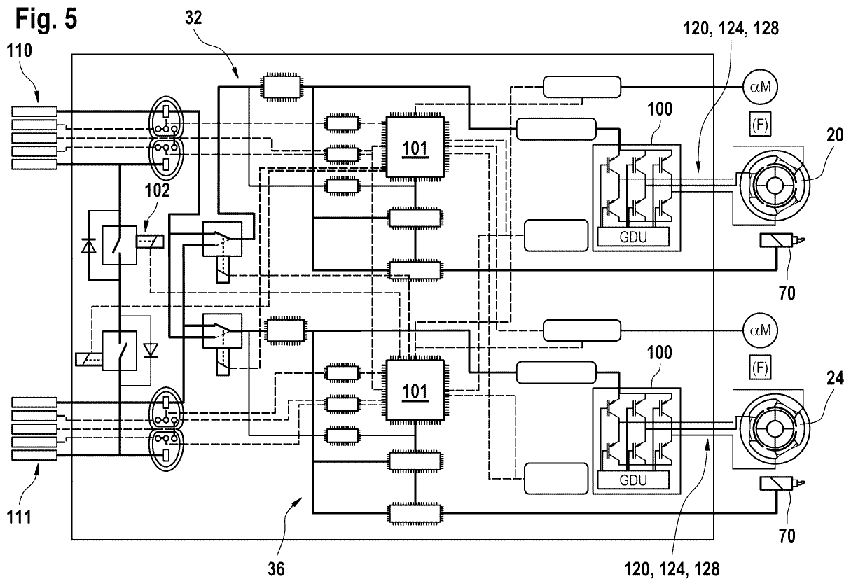

FIG. 5 shows an example of a redundant electronic power unit,

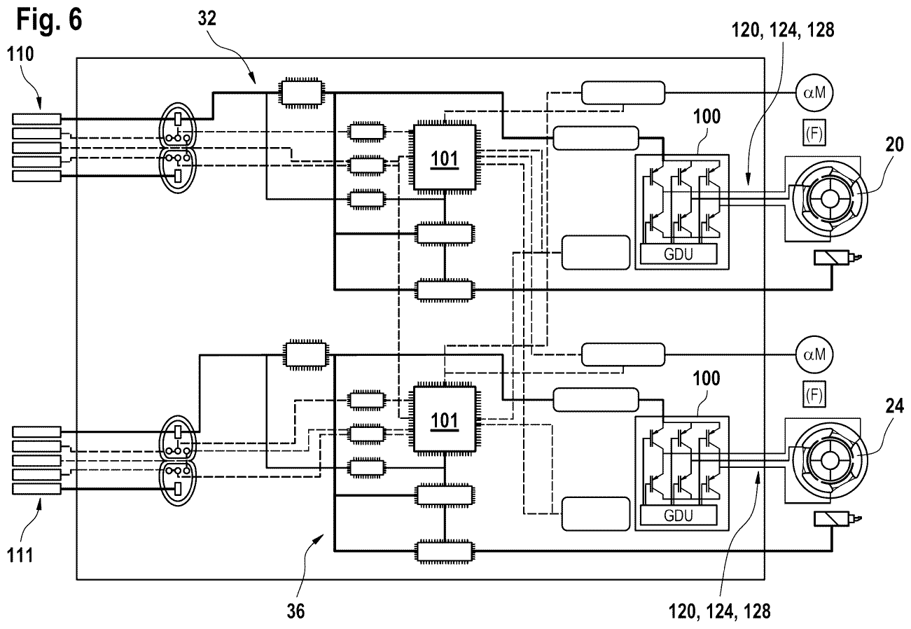

FIG. 6 shows an example of a partially redundant electronic power unit,

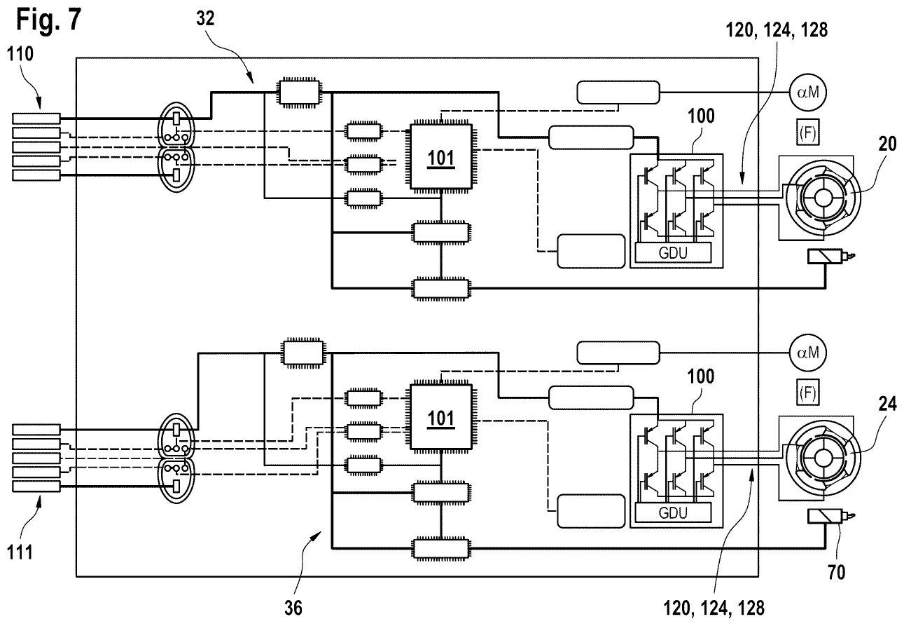

FIG. 7 shows an example of non-redundant electronic power unit,

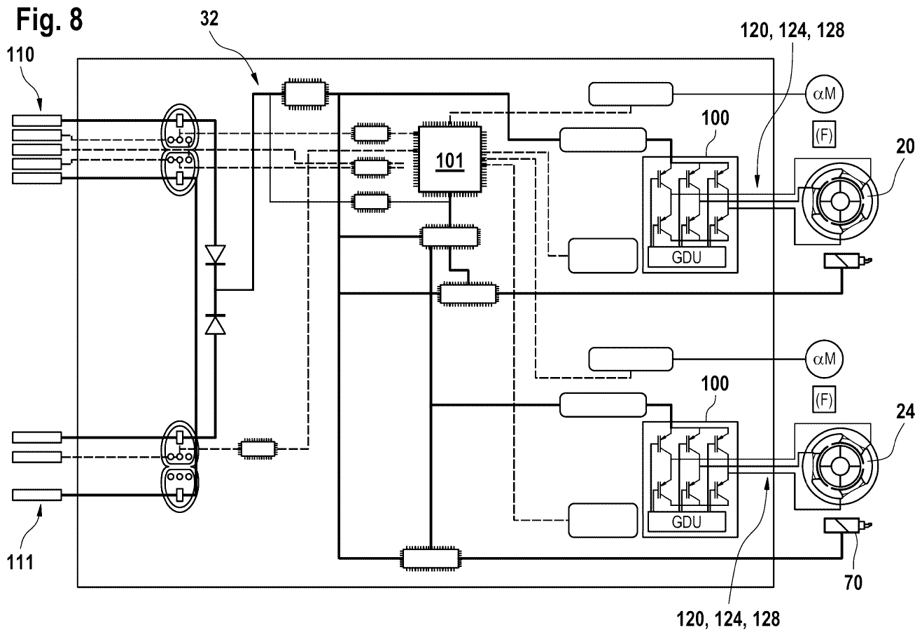

FIG. 8 shows another example of a partially redundant electronic power unit,

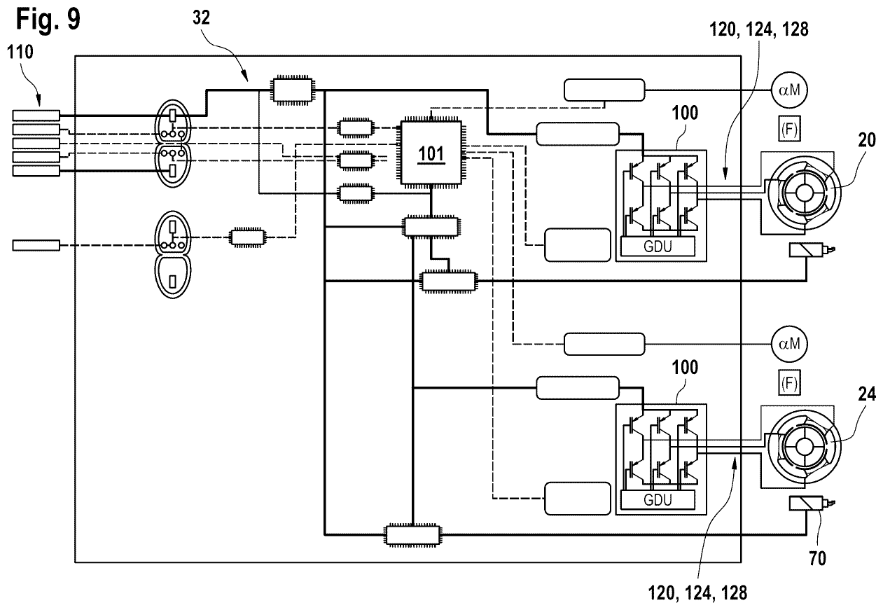

FIG. 9 shows another example of electronic power unit,

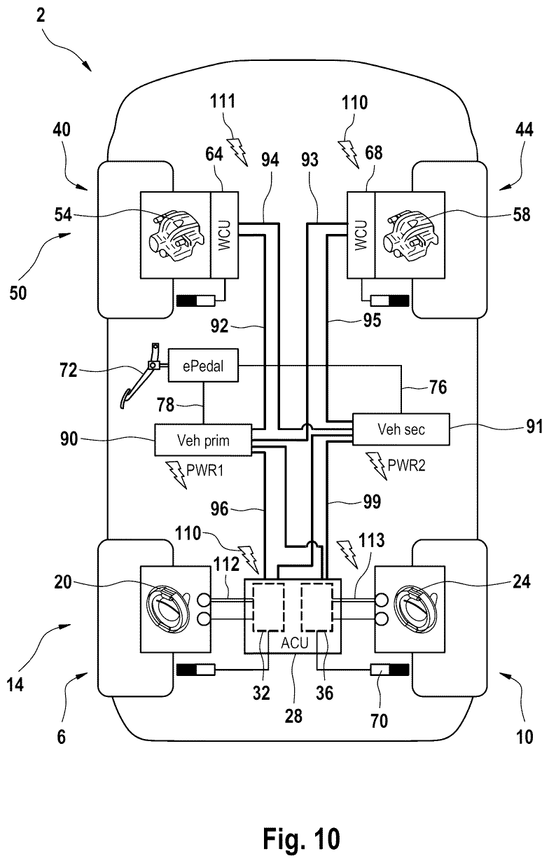

FIG. 10 shows an architecture of another braking system,

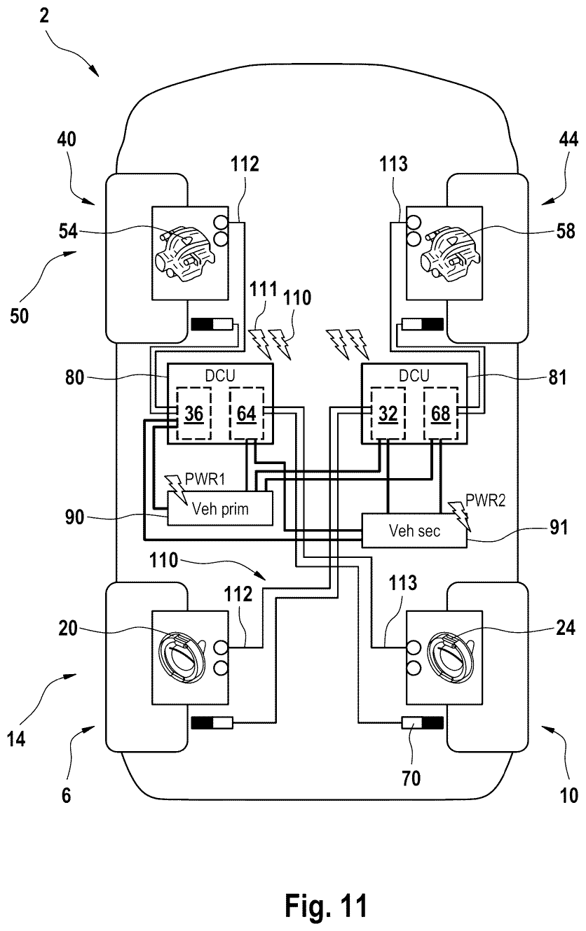

FIG. 11 shows an architecture of yet another braking system,

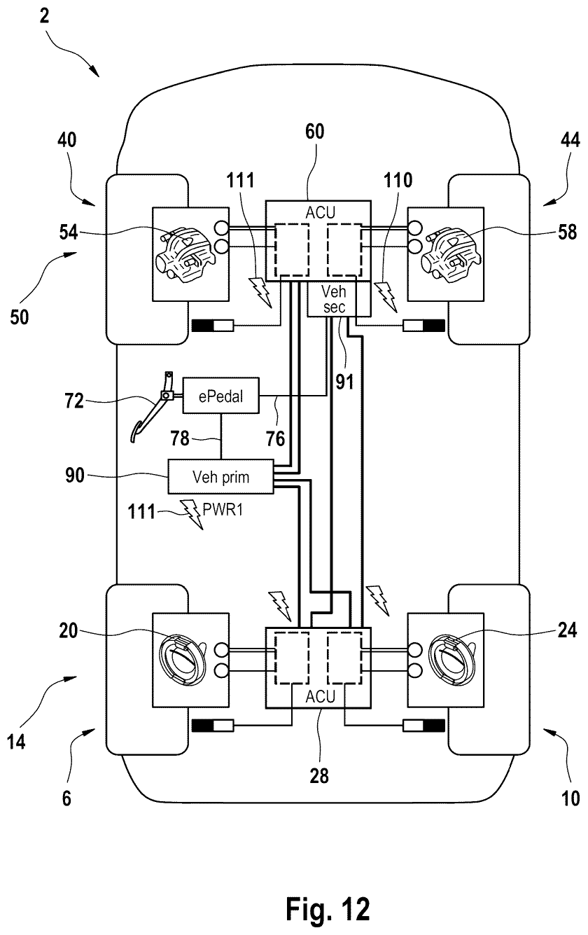

FIG. 12 shows an architecture of yet another braking system,

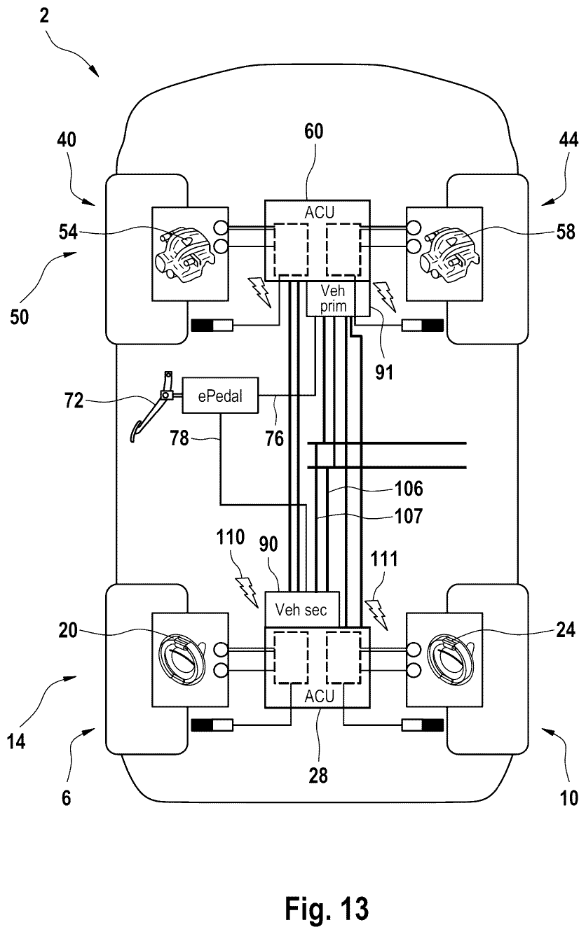

FIG. 13 shows an architecture of yet another braking system, and

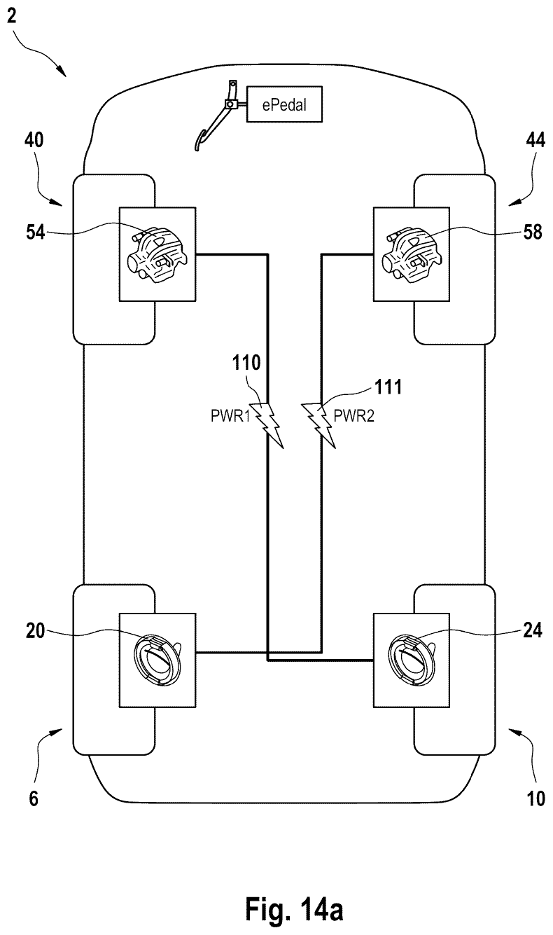

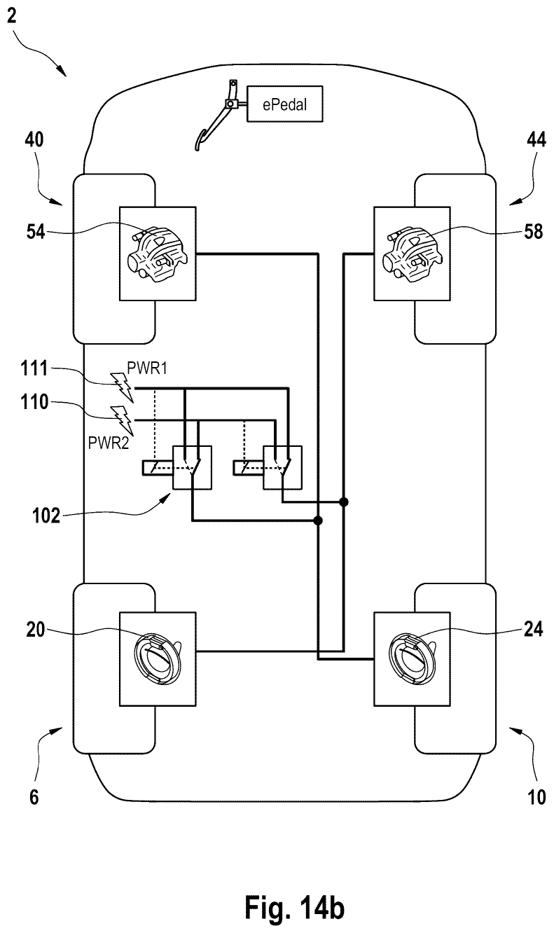

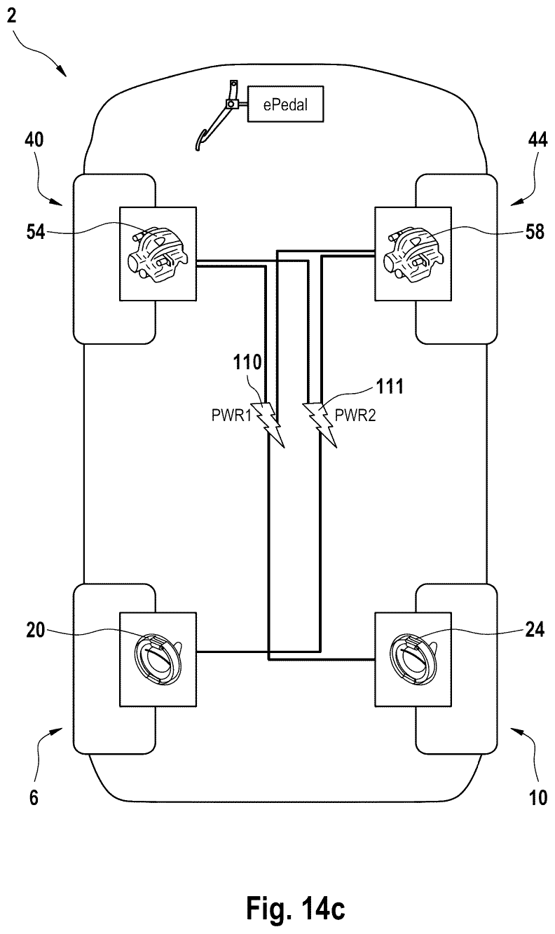

FIGS. 14a-14c show architectures for the power supply of four wheel brakes of a motor vehicle.

### DETAILED DESCRIPTION

In the following detailed description of the embodiments, for the sake of clarity, the same reference signs designate substantially identical parts in or on these embodiments. However, for better clarification, the embodiments illustrated in the figures are not always drawn to scale.

FIG. 1 shows a schematic top view of an example of a braking system 2, for example for a motor vehicle, comprising
a brake pedal 72 with at least one pedal sensor for detecting the driver input;
four electrically controllable wheel brake modules 6, 10, 40, 44, each comprising an electromechanical wheel brake 20, 24, 54, 58,
at least one electronic control unit 90, 91, and
at least one electronic power unit 32, 36, 64, 68, which is designed to control at least one electromechanical wheel brake 20, 24, 54, 58,
wherein the pedal sensor is connected via at least one braking input signal line 76, 78 to at least one electronic control unit 90, 91,
and wherein the at least one electronic control unit 90, 91 is designed to generate control information for the electronic power unit 32, 36, 64, 68 from the braking information of the pedal sensor and to transmit said control information to the electronic power unit 32, 36, 64, 68.

The braking system 2 illustrated in FIG. 1 has two wheel brake modules 6, 10, which are assigned to a rear wheel axle 14 of a motor vehicle and each have a first and a second rear wheel brake 20, 24 (the motors are illustrated in each case).

The braking system 2 furthermore has two wheel brake modules 40, 44, which are assigned to a front wheel axle 50 and each have a first and second front wheel brake 54, 58.

In the exemplary embodiment shown, the electromechanical wheel brakes 20, 24, 54, 58 are embodied as electromechanical disk brakes. Nevertheless, the electromechanical wheel brakes may also be embodied as electromechanical drum brakes, for example, the two wheel brakes 20, 24 assigned to the rear axle 14.

In the exemplary embodiment, the braking system 2 is embodied as a dry by-wire braking system and has a dry brake pedal 72 (electronic pedal in the present case). In the illustrated exemplary embodiment, the brake pedal comprises two sensors, which are based on two different measuring principles. One is a force sensor, which detects the force with which the driver steps on the pedal, and the other is a travel sensor, which measures the distance by which the driver depresses the pedal. In this way, a redundancy with regard to the detection of the driver braking input can be established, since in these different sensors the fault patterns are different, and therefore, for example, a jammed pedal can be detected by force being exerted on the pedal without the latter moving. For example, the signals of these two sensors are therefore sent from the brake pedal 72 as braking information to a first electronic control unit 90 (“Veh prim”, “Brake 1”) and to a second electronic control unit 91 (“Veh sec”, “Brake 2”), which with computer assistance calculates the control information therefrom for the electronic power unit. Other forms of the brake pedal, for example as a “wet” brake pedal, are also possible.

Other necessary components, such as wheel sensors 70, may be mounted on the wheel, such as a motor position sensor and/or a wheel speed sensor.

According to a first aspect, certain functionalities concerning the control and regulation or the operation or power supply of the electromechanical wheel brakes are separated or grouped in accordance with certain criteria.

For a simple connection to existing vehicle concepts and for a high degree of flexibility, therefore, the functionality with regard to the generation of a braking input signal from the signals of the sensor of the brake pedal, on the one hand, and with regard to the control of the wheel brake modules, on the other hand, is separated from each other. This makes it easy to realize certain redundancy requirements.

Accordingly, therefore, an electronic control unit 90, 91 is provided, which is connected to the brake pedal 72. On the basis of the sensor signals, braking information or signals for the electromechanical braking system 2 that correspond to the driver brake input can be generated. The brake pedal 72 is in each case connected to the electronic control units 90, 91 by means of a braking input signal line 76, 78. In the present case, the two braking input signal lines 76, 78 are of bidirectional design.

This electronic control unit 90, 91 is designed to generate control information for the electronic power unit 32, 36, 64, 68 from the signals of the at least one pedal sensor of the brake pedal 72 and to transmit said control information to the electronic power unit 32, 36, 64, 68. This can be for example with computer assistance on the basis of stored algorithms or by means of appropriate software. For this purpose, the electronic control unit 90, 91 may include a corresponding microprocessor with a memory.

In the present case, the electronic control unit 90, 91 is furthermore connected to the motor vehicle via a data bus. For this purpose, in the exemplary embodiment of FIG. 1, two data bus lines 106, 107, in the example CAN bus systems, are schematically shown. This also enables the redundancy requirements to be met, for example in the event of failure of a data bus line 106, 107. The electronic control unit 90, 91 can also be connected to an on-board computer via the data bus. In this way, it is also possible to be able to access algorithms or software of the on-board computer in order to generate the control information. Furthermore, it is also possible for the control information to be generated on-board and transmitted to the braking system 2 via the electronic control unit 90, 91.

As can be seen in FIG. 1, for reasons of redundancy, the electronic control unit 90, 91 is embodied twice, i.e. the elements assigned to the electronic control unit, e.g., electronic components such as microprocessors, are accommodated in two spatially separate and spaced apart modules or housings. The functionality of the two electronic control units 90, 91 is preferably identical, i.e., a first electronic control unit 90, 91 has the same functional scope as the second electronic control unit 90, 91, and therefore complete redundancy is provided. For communication with each other, the two electronic control units 90, 91 are connected to each other via two data bus lines 96, 97, and therefore also in this respect redundant data transmission is possible.

In this case, according to an embodiment, a first electronic control unit 90 can be operated in control mode, and the second electronic control unit 91 can initially be operated in “stand-by” mode. In the event of a failure of the first electronic control unit 90, the required functionality can then be completely taken over by the second electronic control unit 91.

Furthermore, as illustrated in FIG. 1, the two electronic control units 90, 91 are each equipped with a separate power supply, the first electronic control unit 90 accordingly with a first supply voltage 110 and the second electronic control unit 91 with a second supply voltage 111.

A braking system 2 with two such electronic control units 90, 91 makes it possible in a highly advantageous manner to provide different architectures and control concepts for the individual wheel brake modules.

For example, as illustrated in FIG. 1, at the front axle 50, the electronic power unit 64, 68 can be respectively assigned to the associated electromechanical wheel brake 54, 58. In this case, the wheel brake modules 40, 44 are each connected via a redundant data bus line 92, 93 to the first electronic control unit 90 and via a further, likewise redundant data bus line 94, 95 to the second electronic control unit 91. Furthermore, for each electronic power unit 64, 68, a power supply is provided by a corresponding supply voltage 110, 111 at the wheel brake modules.

Insofar as the electronic power units 64, 68 are directly assigned to the associated electromechanical wheel brakes 54, 58, the control is performed via the data bus lines 92, 93, 94, 95 between the electronic control units 90, 91 and the electronic power units 64, 68.

Owing to the functional separation, at the rear axle 14, as shown in FIG. 1, an axle controller 28 or an axle control unit (“ACU”) may be provided, which comprises the electronic power units 32, 36 for controlling the rear wheel brakes 20, 24. The axle controller 28 thus belongs to the sprung masses, which has a favorable effect on the driving behavior. For this purpose, in the exemplary embodiment, a first electronic power unit 32 for controlling the first rear wheel brake 20 (e.g. for a left-hand vehicle wheel) and a second electronic power unit 36 for controlling the second rear wheel brake 24 (e.g. for a right-hand vehicle wheel) are provided in the axle controller 28.

In the exemplary embodiment of FIG. 1, the axle control unit 28 is internally divided into two independent wheel control units or electronic power units 32, 26, which for redundancy reasons have a separate power supply with two supply voltages 110, 111 (KI30 per circuit board). The two electronic power units 32, 36 are accordingly separated from each other, but arranged in a common housing of the axle controller 28. The two electronic power units 32, 36 can also be arranged on a common circuit board, as shown in the following examples, which simplifies the production.

The electric motor of the electromechanical wheel brake 20 is supplied directly with power via the power line 112 by the electronic power unit 32, and the electric motor of the electromechanical wheel brake 24 via the power line 113 by the electronic power unit 36. In addition, signal lines 114, 115 to the wheel brakes 20, 24 are provided. In a manner known to a person skilled in the art, the electric motor can correspondingly apply an application force in an electromechanical disk brake or an expansion force in an electromechanical drum brake, with a transmission with a corresponding converter being able to be provided.

Redundant data transmission may also be provided between the electronic power units 32 and 36 of the axle controller 28. The two electronic power units 32, 36 are configured to be fully redundant, and therefore, in the event of failure of one electronic power unit 32, the other electronic power unit 36 can take over the functionality of the control of the two wheel brakes 20, 24.

In the exemplary embodiment, the two wheel brake modules 6, 10 each have, for example, a pawl or other locking options, or said pawl is integrated in the wheel brake module 6, 10, thereby realizing the functionality of an electronic parking brake.

In other embodiments of the braking system 2 all of the wheel brake modules 6, 10, 40, 44 may also have a pawl or other locking options, with regard to driverless driving requirements.

In a development, a braking system 2 is proposed, in which an electronic control unit 90, 91 is arranged adjacent to or together with an axle controller, preferably in a common module or even in a common housing. This enables certain functionalities in turn to be bundled together. In the exemplary embodiment shown in FIG. 1, the second electronic control unit 91 is arranged spatially adjacent to the axle controller 28. In a preferred embodiment of the invention, the electronic control unit 91 and the axle controller 28 are accommodated in a common module or a common housing, as indicated in FIG. 1.

Such an architecture as shown in FIG. 1 may be simple to integrate in the vehicle and to realize, since, for example, a power supply has to be produced only for this module and not to an electronic control unit 90, 91 and an axle controller. The power supply can in turn correspondingly be configured redundantly with two separate supply voltages 110, 111, as shown in FIG. 1.

FIG. 2 shows a schematic top view of an architecture for another braking system 2. Also in this exemplary embodiment, as in the architectures also presented below of braking systems 2, the braking system 2 is designed as a by-wire braking system and has a dry brake pedal 72. The brake pedal also comprises two sensors which are based on two different measuring principles.

In the exemplary embodiment of FIG. 2, the electromechanical wheel brakes 54, 58 of the front axle 51 are also embodied as electromechanical disk brakes, whereas the electromechanical wheel brakes 20, 24 of the rear axle 14 are embodied as electromechanical drum brakes.

The electronic power unit 32, 36, 64, 68 is in each case directly assigned to the associated electromechanical wheel brake 40, 44, 54, 58, as a result of which the circumference of the unsprung masses increases. In this embodiment, data bus lines 92, 93, 96, 97 are provided between the first electronic control unit 90 and the electronic power units 32, 36, 64, 68, and further data bus lines 94, 95, 98, 99 are provided between the second electronic control unit 91 and the electronic power units 32, 36, 64, 68. For the sake of clarity, the data bus lines of the vehicle are not always shown in this illustration and the following illustrations.

The electronic control units 90, 91 are in turn correspondingly configured redundantly, and therefore, in the event of failure of the first electronic control unit 90, the second electronic control unit 91 can take over the operation of the electromechanical wheel brakes 40, 44, 54, 58. Even if shown separately in FIG. 2, in this embodiment, the two electronic control units 90, 91 can also be accommodated in a common module or in a common housing, which can facilitate the connection to the data bus of the motor vehicle and the power supply. In such arrangements, however, for reasons of redundancy, two separate supply voltages 110, 111 are provided for each electronic control unit 90, 91.

The electronic power unit 32, 36, 64, 68 (“ECU”), in this case also referred to as the so-called “Wheel Control Unit” or “WCU”, can be correspondingly configured simply and per axle is supplied with a first or a second supply voltage 110, 111, in the example in a diagonal manner, i.e., the supply voltages at the front left and rear right as well as at the front right and rear left belong to different power supplies.

In this example, the electronic power unit 32, 36, 64, 68 is identical for each wheel and comparatively simply constructed, as shown in FIG. 3, but has to be provided for each wheel. In the case of separate electronic power units which are directly assigned to a wheel, a microprocessor 101 (“MCU”) also has to be provided, which ensures communication with the data buses and controls the assigned electronic power unit of the respective wheel.

If one of the two electronic control units 90, 91 fails, no drop in braking power should be anticipated. Instead, a warning is generated, for example, by lighting of a warning lamp.

FIG. 3 shows a schematic circuit diagram of an electronic power unit 32, 36, 64, 68 (WCU) for an architecture according to the exemplary embodiment of FIG. 2. The electronic power unit 32, 36, 64, 68 has a B6 bridge 100. Three lines 120, 124, 128 lead from the B6 bridge 100 to the motor of the respective wheel brake 20, 24, 54, 58 and thus each represent the power lines 112, 113. Furthermore, in the example shown, the electronic power unit 32, 36, 64, 68 comprises a microprocessor 101.

FIG. 4 shows a schematic top view of another example of an architecture of a braking system 2, which is similar to the one shown in FIG. 2 with regard to the electromechanical wheel brakes 20, 24, 54, 58.

In this exemplary embodiment, the electronic power units 32, 36, 64, 68 are, however, in each case combined in pairs per axle, i.e., a second axle controller 60 which comprises the electronic power units 64, 68 is provided. As a result, the undampened mass at the wheels can be further reduced, since all of the electronic power units can be arranged, for example, in a favorable center of gravity position in a central region of the motor vehicle.

In this exemplary embodiment, the electronic power units 32, 36, 64, 68 in the two axle controllers 28, 60 are connected to each other with the likewise two electronic control units 90, 91 via the corresponding data bus lines 92, 93, 94, 95, 96, 97, 98, 99. Power lines 112, 113 lead from the axle controllers 28, 60 to the electromechanical wheel brakes 20, 24, 54, 58. A separate on-board supply of power to the wheel brake modules can therefore be omitted.

The combining of functionalities, for example with regard to the electronic power units 32, 36, 64, 68, into one or two axle controllers 28, 60 makes it possible, for example also in conjunction with two electronic control units 90, 91 as shown in FIG. 1 or 2, to design the electronic power units 32, 36, 64, 68 customer-specifically.

Customer-specific requirements regarding safety or requirements for the redundancy of certain elements can be realized here.

FIGS. 5 to 9 below show, purely by way of example in in each case a simplified illustration, various circuit diagrams for electronic power units 32, 36, 64, 68, which can be used for or with a braking system 2. In the examples, a circuit board combining the required functionality is provided for each axle controller 28, 60. A single circuit board can often be manufactured and installed. However, it is also possible to provide a separate circuit board for each electronic power unit and to provide said circuit boards in a common housing.

The embodiments make it to realize different configurations of the respective electronic power units 32, 36, 64, 68, since the brake pedal 72 and/or the interface with the data bus of the motor vehicle is not connected to the axle controllers 28, 60 and, in this respect, a high degree of flexibility arises with regard to the redundancy of individual elements or components of the electronic power units 32, 36, 64, 68.

It should be noted at this point that the following embodiments apply in an analogous manner with regard to the redundancy of the electronic power units 32, 36, 64, 68 also to the diagonal controllers 80, 81 described in more detail further below.

A person skilled in the art understands that, in the event of two axle controllers 28, 60, the respective electronic power unit for controlling the wheel brakes 20, 24, 54, 58 can be designed identically or differently. In other words, the two axle controllers 28, 60 may comprise identically designed electronic power units 32, 36, 64, 68, but also differently designed ones, for example, with different redundancy.

FIG. 5 shows an example of fully redundant electronic power units 32, 36 for an axle controller, each electronic power unit 32, 36 being provided for controlling a wheel brake 20, 24 of an axle. A person skilled in the art understands that, in the event of combining two electronic power units of a diagonal controller, the electronic power units are correspondingly assigned to the wheel brakes diagonally, as also explained in more detail further below.

In normal operation, the two electronic power units 32, 36 operate independently of each other and control the respective wheel brakes 20, 24 individually. The two electronic power units 32, 36 are each supplied with their own voltage supply 110, 111. In addition, signal lines, for example from the electronic control unit, lead to the two electronic power units 32, 36, which are indicated only for clarity.

If, for example, a power supply fails, the electronic power unit 32, 36 not affected by the failure takes over the control of the two wheel brakes 20, 24. For this purpose, the two electronic power units 32, 36 in the axle controller 28, 60 are connected to each other in such a way that, in the event of failure of a first electronic power unit 32, the second electronic power unit 36 takes over the control of that wheel brake 20, 24 which is assigned to the failed electronic power unit 32.

For this purpose, in the axle controller 28, 60, a data bus line is provided between the two electronic power units 32, 36 and a circuit 102.

The electronic power unit 32, 36 comprises a control connection with a B6 bridge 100 for connection to the further electronic power unit 32, 36. In this way, it is possible, in particular, to connect the three phases of an electric motor of a wheel brake 20, 24 to the other electronic power unit 32, 36. To ensure electronic redundancy, the B6 bridge/GDU on one side is used, if a B6 bridge/GDU on the other side fails, to synchronously control both motors of the electromechanical wheel brakes 20, 24. In this case, it is then only possible to operate the motors synchronously, but this is sufficient for brake boosting. A prerequisite here is that both motors have the same alignment angle, this being made possible by synchronized driving at the start of motor control.

A cross switch is arranged in the respective control connection 102. Fuses may be arranged in the respective connection between a B6 bridge and a wheel brake. The B6 bridge on the side of the functioning control unit is used to burn through the fuses, which may be designed as ETFs (electric thermal fuses), in the control connection of the non-functioning control unit. A cross switch is therefore required from each side behind the ETFs of the other side.

The complete redundancy here comprises the failure of a power supply or supply voltage 110, 111 in one of the two electronic power units 32, 36, the failure of the signal of a motor position sensor 72 or else the failure of a microprocessor 101. In these cases, the redundant configuration of the electronic power units 32, 36 ensures that the electronic power unit 32, 36 not affected in each case takes over the functions of the one affected by the fault.

FIG. 6 shows an example of a partially redundant electronic power unit 32, 36 of an axle controller 28, 60 for the control of each wheel brake 20, 24, 54, 58. In this embodiment, the microprocessor 101 and the B6 bridge 100 are still redundant but the circuit 102 is no longer provided in the extent, as in FIG. 5, for cost reasons. A switchover of the power supply in the event of failure of a supply voltage 110, 111 is therefore no longer provided, and therefore only partial redundancy, rather than complete redundancy, is provided in this configuration of the electronic power unit of the axle controller 28, 60.

It is also possible to form an axle controller 28, 60 with two identical electronic power units 32, 26 without redundancy. In this case, the two combined electronic power units 32, 26 can also be understood as meaning a “WCU” of each wheel. Such an arrangement is shown purely by way of example in FIG. 7. Although there is no redundancy here, since only one printed circuit board is used for the electronic power unit of both wheel brakes of an axle.

FIG. 8 shows another example of a partially redundant electronic power unit 32 of an axle controller 28, 60 for the control of each wheel brake 20, 24, 54, 58. In this embodiment of the axle controller 28, 60, a second, redundant microprocessor 101 is omitted; i.e., only one microprocessor 101 supplies both B6 bridges 100. This results in cost advantages due to the omission of a microprocessor 101; however, the scope of the redundant functions is also correspondingly limited. In other words, in the event of failure of the one microprocessor 101, no control can take place any longer. The electronic power unit is also connected to two supply voltages 110, 111, which can be operated alternately.

FIG. 9 shows another example of an electronic power unit 32 of an axle controller 28, 60 for the control of each wheel brake 20, 24, 54, 58. This embodiment of the axle controller 28, 60 is based on the embodiment of FIG. 8. However, the electronic power unit 32 is only connected to one supply voltage 110, i.e., if this supply voltage fails, it is no longer possible to control the wheel brakes.

FIG. 10 shows a schematic top view of an example of an architecture of another braking system 2, which largely corresponds to the braking system 2 from FIG. 1. Also in this exemplary embodiment, the braking system 2 is designed as a by-wire braking system and has a dry brake pedal 72. The brake pedal also comprises two sensors which are based on two different measuring principles. The rear wheel brakes 20, 24 are embodied as electromechanical drum brakes.

FIG. 11 shows a schematic top view of an example of another braking system 2. The brake pedal and the data bus lines to the vehicle are not shown for the sake of clarity.

However, in this exemplary embodiment, the functionality regarding the control of the respective wheel brakes is combined differently to the other examples. In particular, the exemplary embodiment of FIG. 11 shows that the electronic power units 32, 36, 64, 68 for controlling diagonally opposite wheel brakes 20, 24, 54, 58 are combined in so-called diagonal controllers 80, 81 (“DCU”).

Accordingly, the diagonal controller 80 comprises the electronic power unit 36 for controlling the wheel brake 24 at the rear right and the electronic power unit 64 for controlling the wheel brake 54 at the front left. Furthermore, the diagonal controller 81 comprises the electronic power unit 32 for controlling the wheel brake 20 at the rear left and the electronic power unit 68 for controlling the wheel brake 58 at the front right. The respective electronic power units 32, 36, 64, 68 are accordingly in turn combined in pairs, but in diagonal form, such that, also in this exemplary embodiment, the undamped masses are reduced. Accordingly, power lines 112, 113 have to be provided from the diagonal controllers 80, 81 to the diagonally arranged wheel brakes.

Therefore, in the event of complete failure of one diagonal controller 80, 81, at least one front wheel and one rear wheel can still be braked, whereas, in an arrangement with two axle controllers, in the event of failure of one axle controller 90, 91, each axle can no longer be braked.

The electronic power units 32, 36, 64, 68 of the diagonal controllers 80, 81 can be constructed with regard to redundancy analogously to the embodiments shown in FIGS. 5 to 9. Accordingly, a diagonal controller 80, 81 can comprise electronic power units 32, 36, 64, 68, which are formed analogously to the examples of FIGS. 5 to 9.

According to a development, at least one diagonal controller 80, 81 can also be assigned, for example, to a front wheel or integrated therein.

FIG. 12 shows a schematic top view of an example of an architecture of another braking system 2 with two axle controllers 28, 60. In this embodiment, an electronic control unit 91 is assigned to the axle controller 60 of the front axle.

In comparison to the embodiment shown in FIG. 4 with likewise two axle controllers 28, 60 and two separately arranged electronic control units 90, 91, in this embodiment the power supply can be simplified since the second electronic control unit 91 is structurally combined with the axle controller 60.

FIG. 13 shows a schematic top view of an example of another braking system 2 with two axle controllers 28, 60. In this embodiment, the two electronic control units 90, 91 are respectively assigned to an axle controller 28, 60. In this case, the electronic control units 90, 91 are furthermore connected to the data bus lines 106, 107 of the motor vehicle. In comparison to the embodiment shown in FIG. 12, the required power supply can be further simplified and is limited to a redundant supply voltage 106, 107 to the structurally combined elements of electronic control unit 90, 91 and axle controller 28, 60.

In a further aspect, the functional separation or grouping within also relates to the power supply of the wheel brakes. For this purpose, FIGS. 14a, 14b and 14c show possible architectures for the power supply of four wheel brakes of a motor vehicle on the basis of schematic diagrams.

In the embodiment shown in FIG. 14a, a diagonal power supply to the wheel brakes 20, 24, 54, 58 is provided. A diagonal power supply means a power supply of the wheel brakes, in which diagonally opposite wheel brakes each have the same power supply. As can be seen in FIG. 14a, for this purpose the wheel brakes 58, 20 at the front right and at the rear left are connected to a supply voltage 111 and the wheel brakes 54, 24 at the front left and at the rear right to a supply voltage 110. In the event of a complete failure of one supply voltage 110, 111, this arrangement leads to a halving of the brake boosting. This embodiment allows a simple design of the interface with the wheel brake module 6, 10, 40, 44, which can substantially comprise a connection for the supply voltage and for signal or data lines.

In the embodiment shown in FIG. 14b, a diagonal individual supply of the wheel brakes 20, 24, 54, 58 with power is likewise provided, but with mutual switching over in the event of failure. This circuit 102 is shown schematically in the figure. This leads to the fact that, in the event of failure of one supply voltage 110, 111, the operation of all four wheel brakes still continues to be possible. A targeted axle control, i.e., switching over of the supply of individual wheel brakes, is also conceivable and possible here, such that, for example, only the wheel brakes of the front axle are supplied with power.

In the embodiment shown in FIG. 14c, a dual supply with power of the wheel brakes 54, 58 on the front wheel is provided. A dual supply with power means here a power supply of the front wheel brakes 54, 58, in which each wheel brake has two power supplies. As can be seen in FIG. 14c, the wheel brakes 54, 58 at the front right and at the front left are connected to a first supply voltage 110 and to a first supply voltage 111. If one supply voltage 110, 111 fails, this leads only to failure of the function of a rear wheel brake.

It is obvious to a person skilled in the art that the architectures shown here with regard to the control of the wheel brakes, the design of the power controls and the power supply can be combined with one another in various ways and the architectures shown are simply possible exemplary embodiments.

1. A braking system for a motor vehicle, comprising:
a brake pedal with at least one pedal sensor for detecting the driver input;
a plurality of electrically controllable wheel brake modules each comprising an electromechanical wheel brake;
at least one electronic control unit; and
at least one electronic power unit which is designed to control at least one electromechanical wheel brake;
wherein the pedal sensor is connected via at least one braking input signal line to at least one electronic control unit; and
wherein the at least one electronic control unit is designed to generate control information for the electronic power unit from the braking information of the pedal sensor and to transmit said control information to the electronic power unit.

2. The braking system as claimed in claim 1, wherein the brake pedal comprises at least two pedal sensors, which are at least a force sensor and a travel sensor, and wherein the signals of the two pedal sensors can be transmitted during operation to the electronic control unit.

3. The braking system as claimed in claim 2, wherein each pedal sensor is connected to each of the at least one electronic control unit via a braking input signal for of the at least one electronic control units.

4. The braking system as claimed in claim 1, wherein the electromechanical wheel brakes are one of electromechanical disk brakes and electromechanical drum brakes.

5. The braking system as claimed in claim 1, wherein the electromechanical wheel brake of a front wheel is an electromechanical disk brake and the electromechanical wheel brake of a rear wheel is an electromechanical drum brake.

6. The braking system as claimed in claim 1, wherein the at least one electronic control unit is redundant, and wherein each of the at least one electronic control unit comprises the same functionality as one another with regard to the generation of the control information for the at least one electronic power unit.

7. The braking system as claimed in claim 1, wherein the at least one electronic control unit is at least two electronic control units accommodated in two spatially separated housings from one another.

8. The braking system as claimed in claim 7, wherein at least one data bus line, for data transmission is arranged between the separately arranged electronic control units.

9. The braking system as claimed in claim 1, wherein the at least one electronic control unit is spatially separated from the electronic power unit.

10. The braking system as claimed in claim 8, wherein at least one data bus line is arranged between the at least one electronic control unit and the at least one electronic power unit.

11. The braking system as claimed in claim 1, wherein the at least one electronic control unit comprises at least one microprocessor per electronic control unit.

12. The braking system as claimed in claim 1, wherein the at least one electronic control unit is connected to a data bus of the motor vehicle.

13. The braking system as claimed in claim 1, wherein each electronic control unit has its own; separate supply voltage.

14. The braking system as claimed in claim 1, wherein is at least two electronic control units accommodated in a common module or in a common housing.

15. The braking system as claimed in claim 1, wherein at least one of a front axle and a rear axle the at least one electronic power unit is directly assigned to the associated electromechanical wheel brake.

16. The braking system as claimed in claim 1, wherein at least one of a front axle and a rear axle an axle controller is provided, which comprises the at least one electronic power unit for controlling the associated electromechanical wheel brakes located at that axle.

17. The braking system as claimed in claim 1, wherein at least one diagonal controller is provided, which comprises the at least one electronic power unit for controlling diagonally opposite wheel brakes.

18. The braking system as claimed in claim 1, wherein at least one electronic control unit and one of the at least one electronic power unit, an axle controller, and a diagonal controller are accommodated in a common housing.

19. The braking system as claimed in claim 1, wherein the at least one electronic power units of an axle controller or a diagonal controller each have a separate supply voltage.

20. The braking system as claimed in claim 1, wherein the electronic power units of an axle controller or a diagonal controller are redundant.

21. The braking system as claimed in claim 1, wherein the electronic power units of an axle controller or a diagonal controller have just one common supply voltage.

22. The braking system as claimed in claim 1, wherein the electronic power units of an axle controller or a diagonal controller have a common microprocessor.

23. The braking system for a motor vehicle; comprising
a brake pedal with at least one pedal sensor for detecting driver input;
a plurality of electrically controllable wheel brake modules each comprising an electromechanical wheel brake, and at least one electronic power unit to control the respective electromechanical wheel brake; and
one of an axle controller and a diagonal controller having the electronic power unit for controlling at least two of the plurality of electromechanical wheel brakes.

24. The braking system as claimed in claim 23 further comprising;
an at least one electronic control unit, wherein the at least one pedal sensor is connected via at least one braking input signal line to the electronic control unit; and
wherein the at least one electronic control unit is designed to generate control information for the electronic power unit from the braking information of the pedal sensor and to transmit said control information to the electronic power unit.

25. The braking system as claimed in claim 23,
wherein a diagonal power supply is provided to the wheel brakes in which in each case diagonally opposite wheel brakes are connected to the same supply voltage.

26. The braking system as claimed in claim 23, wherein a power supply comprises a switching unit for reciprocal switching over in the event of failure of a supply voltage.

27. The braking system as claimed in claim 23,
wherein a power supply supplies power to front wheel brakes of the plurality of wheel brakes, wherein each wheel brake of the front wheel brakes is connected to a respective front wheel by a first supply voltage and by a second supply voltage; and
wherein rear wheel brakes of the plurality of wheel have a single power supply.

28. (canceled)

29. The braking system as claimed in claim 1, wherein the brake pedal is a dry brake pedal.
